(19) United States
(12) Patent Application Publication
(10) Pub. No.: US 2011/0134125 A1
(43) Pub. Date: Jun. 9, 2011

(54) FLAT PANEL DISPLAY AND IMAGE PROCESSING METHOD FOR POWER SAVING THEREOF

(75) Inventor: Jie-Wei Chen, Taipei County (TW)

(73) Assignee: INSTITUTE FOR INFORMATION INDUSTRY, Taipei (TW)

(21) Appl. No.: 12/636,785

(22) Filed: Dec. 14, 2009

(30) Foreign Application Priority Data
Dec. 3, 2009 (TW) 98141365

(51) Int. Cl. G09G 3/30; G06T 17/00

(52) U.S. Cl. 345/428; 345/605; 345/77

(57) ABSTRACT

An image processing method for power saving is provided and includes the following steps. An original image is converted to a specific color space, so as to obtain a target image. A color converting table is created according to a color difference offset range, in which the color converting table records a plurality of power-saving pixel values. The color converting table is looked up, so as to convert original pixel values of a plurality of pixels of the target image into a part of power-saving pixel values. Furthermore, an output image is generated by using pixels with the part of the power-saving pixel values.

### CROSS-REFERENCE TO RELATED APPLICATION

This application claims the priority benefit of Taiwan application serial no. 98141365, filed on Dec. 3, 2009. The entirety of the above-mentioned patent application is hereby incorporated by reference herein and made a part of specification.

### BACKGROUND OF THE INVENTION

1. Field of the Invention

The present invention generally relates to a display device and an image processing method thereof, in particular, to a flat panel display and an image processing method for power saving thereof.

2. Description of Related Art

Along with the rapid development of information technology, various portable electronic devices, such as computers, mobile phones, personal digital assistants (PDAs), and digital cameras, have been emerged and upgraded continuously. In the portable electronic devices, displays always play an important role. Thanks to the advantages of desirable space utilization, high definition, low power consumption, and free of radiation, flat panel displays have been widely applied in the electronic devices.

Currently, common flat panel displays include, for example, liquid crystal displays (LCDs), plasma display panels (PDPs), and organic light-emitting diode (OLED) displays. The OLED display has the advantages of self emission, power saving, simple manufacturing process, broad viewing angle, high response speed, and low cost, and thus is quite applicable to small-sized displays for electronic clocks, mobile phones, PDAs, and digital cameras.

However, although it seems that the OLED display has the power saving advantage, during the practical operation, when the OLED display shows a picture in a full white mode, the consumed power is usually more than that consumed by an LCD. Therefore, it is still a problem to be solved in the design of OLED displays about how to reduce the power consumption directed to different types of images to be displayed.

### SUMMARY OF THE INVENTION

Accordingly, the present invention is directed to an image processing method for power saving, which replaces original pixel values of all pixels by power-saving pixel values through looking up a color converting table, thereby effectively reducing power consumption of a display panel.

The present invention is further directed to a flat panel display, which adjusts original pixel values of pixels by using an image conversion unit, thereby reducing power consumption of an OLED display panel.

The present invention provides an image processing method for power saving, which includes the following steps. First, an original image is converted to a specific color space, so as to obtain a target image with a resolution of N bits, in which each of a plurality of pixels in the target image includes M sub-pixels, and N and M are positive integers. Next, a color converting table is created according to a color difference offset range and 2^{N*M} reference pixel values, in which the color converting table records 2^{N*M} power-saving pixel values. Then, the color converting table is looked up, so as to convert original pixel values of the plurality of pixels in the target image into a part of the power-saving pixel values. Finally, an output image is generated by using the pixels with the part of the power-saving pixel values.

In an embodiment of the present invention, the step of creating the color converting table according to the color difference offset range and the 2^{N*M} reference pixel values includes: setting a power-saving pixel value field in the color converting table, in which the power-saving pixel value field is used for recording the power-saving pixel values; generating the 2^{N*M} reference pixel values; determining a position for arranging an i^{th} power-saving pixel value according to N sub-pixel values of an i^{th} reference pixel value, such that the power-saving pixel values are sequentially arranged in the power-saving pixel value field according to index values of the color converting table, in which i is an integer and 0≦i≦(2^{N*M}−1); and performing a color difference operation on the i^{th} reference pixel value based on the reference pixel values, and selecting one from the reference pixel values according to the color difference offset range and a color power consumption table, so as to serve as the i^{th} power-saving pixel value.

In addition, the present invention provides a flat panel display, which includes an OLED display panel, an input unit, a storage unit, and an image conversion unit. The input unit is used for receiving an original image, and converting the original image to a specific color space, so as to obtain a target image with a resolution of N bits, in which each of a plurality of pixels in the target image includes M sub-pixels, and N and M are positive integers. The storage unit is used for storing a color converting table, in which the color converting table is corresponding to a color difference offset range, and records 2^{N*M} power-saving pixel values. The image conversion unit is used for converting original pixel values of the plurality of pixels in the target image into a part of the power-saving pixel values according to the color converting table. In addition, the flat panel display generates an output image by using the pixels with the part of the power-saving pixel values, and displays the output image through the OLED display panel.

In view of the above, the present invention replaces original pixel values of all pixels by power-saving pixel values through looking up the color converting table. Therefore, a specific color difference may exist between the output image generated by using the power-saving pixel values and the original image, and the specific color difference can be adjusted by using different color difference offset ranges. Thus, the output image can reduce the power consumption of the display panel while satisfying the displaying quality requirements of the electronic devices.

In order to make the features and advantages of the present invention more comprehensible, embodiments are illustrated in detail below through accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of an image processing method for power saving according to an embodiment of the present invention.

FIG. 2 is a relation diagram between power-saving efficiency and color difference of FIG. 1.

FIG. 3 is a flow chart for showing detailed processes of Step S130.

FIG. 4 shows a color converting table for Step S130.

FIG. 5 is a schematic block diagram of a flat panel display according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

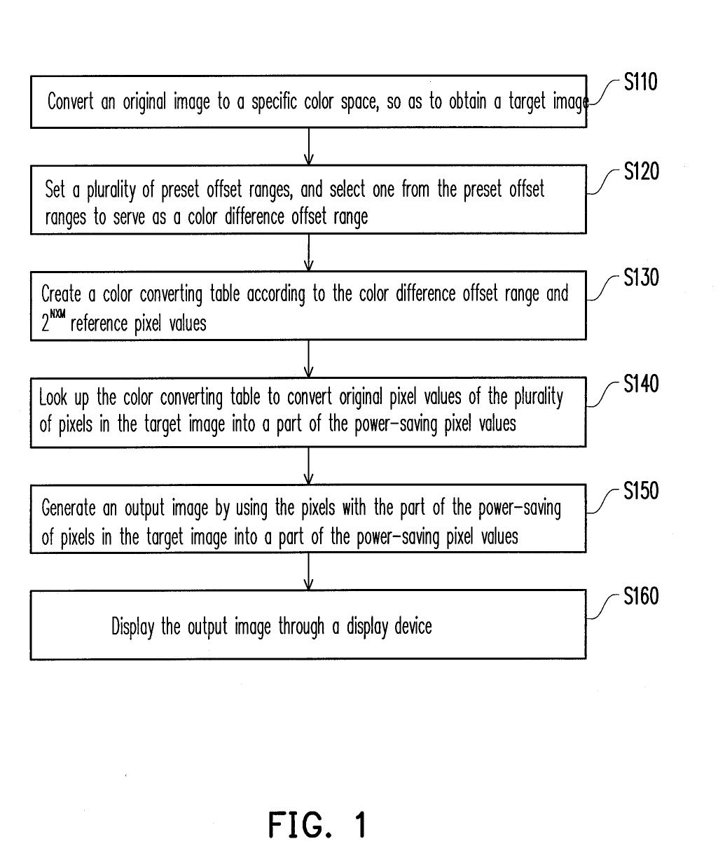

FIG. 1 is a flow chart of an image processing method for power saving according to an embodiment of the present invention. Referring to FIG. 1, first, in Step S110, an original image is converted to a specific color space such as an RGB color space, a YUV color space, and an XYZ color space, so as to obtain a target image with a resolution of N bits, and N is a positive integer. For example, if the original image is converted to the RGB color space, the target image obtained in this case includes a plurality of pixels, and each of the plurality of pixels includes three sub-pixels of red, green, and blue colors respectively. Furthermore, if the target image has a resolution of 8 bits (N=8), the sub-pixel value of each sub-pixel falls between 0 and 255. For ease of illustration, the following steps are illustrated by taking the target image mentioned above as an example.

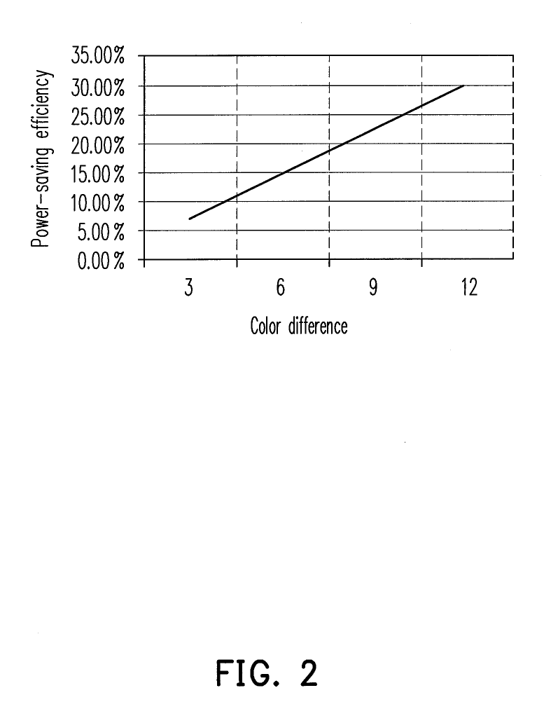

Before color conversion is performed on the target image, the influences caused by color differences (ΔE) on human eyes and a power saving mechanism must be learned first. Generally speaking, when a color difference between two color points is smaller than 3, that is, ΔE≦3, the difference between the two color points cannot be recognized by the human eyes. Furthermore, when a color difference between two color points is larger than 3 and smaller than 6, that is, 3≦ΔE≦6, the difference between the two color points can only be recognized by experts. Moreover, when a color difference between two color points is larger than 6 and smaller than 13, that is, 6≦ΔE≦13, the difference between the two color points can be recognized by human eyes through careful observation. However, considering the power consumption of the display panel, the larger the color difference is, the higher the power-saving efficiency will be, as shown in the relation diagram between the power-saving efficiency and the color difference in FIG. 2. In other words, for various portable electronic devices, suitable color differences may be set according to the corresponding application properties thereof to satisfy the power consumption and displaying quality requirements.

Therefore, before the color conversion is performed on the target image, in Step S120, a plurality of preset offset ranges is set, such as a preset offset range between 3 and 6, a preset offset range between 6 and 9, and a preset offset range between 9 and 12, and one preset offset range is selected from the plurality of preset offset ranges to serve as a color difference offset range. Therefore, the color conversion is performed for the target image based on the selected color difference offset range, for example, the preset offset range between 6 and 9.

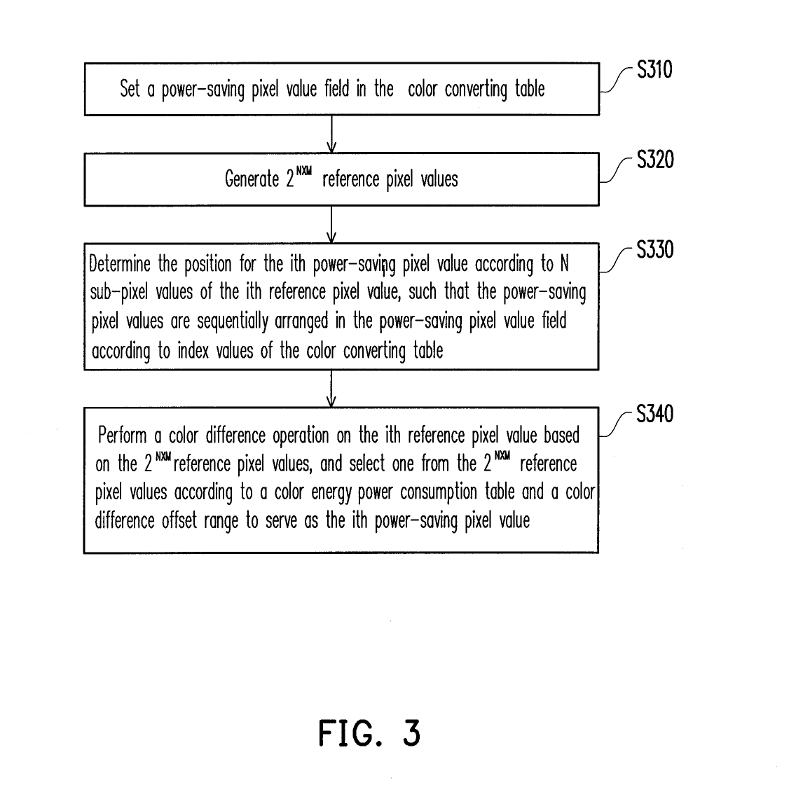

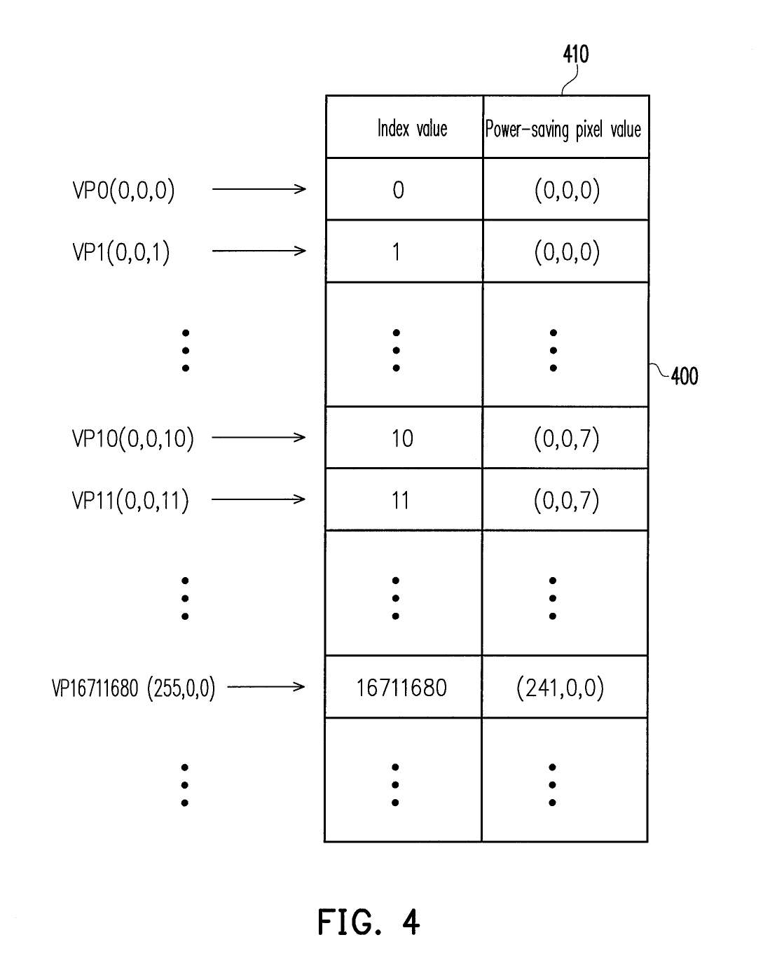

In this embodiment, the color conversion of an image is performed by looking up a table. Therefore, after selecting the tolerable color difference range, in Step S130, a color converting table is created according to the selected color difference offset range and 2^{N*M} reference pixel values. The process for creating the color converting table is described below. FIG. 3 is a flow chart for showing detailed processes of Step S130, and FIG. 4 shows a color converting table for Step S130. Referring to FIGS. 3 and 4, during the color conversion process, first, in Step S310, a power-saving pixel value field is set in the color converting table, for example, a power-saving pixel value field 410 is set in a color converting table 400 of FIG. 4.

Then, in Step S320, 2^{N*M} reference pixel values are generated. For example, if each pixel in the target image includes 3 sub-pixels (that is, M=3), and the sub-pixel value of each sub-pixel falls between 0 and 255 (that is, N=8), 256³ reference pixel values may exist for making reference. For ease of illustration, in this embodiment, an i^{th} reference pixel value is marked as VPi(r, g, b), in which r, g, and b are respectively three sub-pixel values for forming the reference pixel value, i is an integer and 0≦i≦255. For example, VP0(0, 0, 0) shown in FIG. 4 represents the 0^{th} reference pixel value and it is formed by sub-pixel values R{0}, G{0}, and B{0}. It should be noted that, as shown in FIG. 4, each reference pixel value has a corresponding power-saving pixel value, thereby facilitating the conversion of the target image. In other words, the power-saving pixel value field in the color converting table 400 is used for recording 256³ power-saving pixel values.

As for the positions for arranging the power-saving pixel values, the sub-pixel values R{0}, G{0}, and B{0} for forming the 0^{th} reference pixel value VP0(0, 0, 0) are respectively converted into corresponding digital values {00000000}, {00000000}, and {00000000}, and then the digital values obtained through conversion are combined into a 24-bit digital value, that is, {000000000000000000000000}. In other words, the digital value {00000000} of the sub-pixel value R is shifted by 16 bits, and the digital value {00000000} of the sub-pixel value G is shifted by 8 bits, so as to generate the 24-bit digital value. Subsequently, an OR gate operation is performed on the 24-bit digital value, so as to obtain a value {0}, and then the value {0} is taken as a basis for arranging the 0^{th} power-saving pixel value.

Similarly, sub-pixel values R{0}, G{0}, and B{1} for forming the 1^{st} reference pixel value VP1(0, 0, 1) are combined into a 24-bit digital value, that is, {000000000000000000000001}, and an OR gate operation is performed on the obtained 24-bit digital value, so as to obtain a basis for arranging the 1^{st} power-saving pixel value, and so forth. Therefore, the 256³ power-saving pixel values may be sequentially arranged in the power-saving pixel value field 410 according to index values of the color converting table 400. In other words, in Step S330, the position for arranging the power-saving pixel value is determined according to N sub-pixel values of the i^{th} reference pixel value, such that the power-saving pixel values are sequentially arranged in the power-saving pixel value field according to the index values of the color converting table, in which i is an integer and 0≦i≦(2^{N*M}−1).

As for the setting of power-saving pixel values, in Step S340, a color difference operation is performed on the 0^{th} reference pixel value VP0 based on the 256³ reference pixel values VP0, VP1, VP2, VP3, VP4 . . . , so as to obtain 256³ color difference values ΔE0-0, ΔE0-1, ΔE0-2, ΔE0-3, ΔE0-4 . . . accordingly. Then, many color differences in the color difference offset range are selected, for example, ΔE0-0 and ΔE0-4, so as to find out the reference pixel values similar to the 0^{th} reference pixel value VP0, for example, VP0 and VP4. Then, a reference pixel value having a minimum power consumption is selected from the reference pixel values similar to the 0^{th} reference pixel value VP0 according to a color power consumption table, for example, VP0, so as to serve as the 0^{th} power-saving pixel value. The color power consumption table records the power consumption corresponding to the 256³ reference pixel values respectively.

Similarly, a color difference operation is performed on the 10^{th} reference pixel value VP10 based on 256³ reference pixel values VP1, VP2, VP3, . . . , so as to generate 256³ color differences ΔE10-1, ΔE10-1 , ΔE10-3, . . . . Then, reference pixel values similar to the 10^{th} reference pixel value VP10, for example, VP1, VP2, and VP7, are selected from the 256³ reference pixel values according to the color differences ΔE10-1, ΔE10-1, ΔE10-3, . . . . Then, a reference pixel value having a minimum power consumption is selected from the reference pixel values similar to the 10^{th} reference pixel value VP10 according to a color power consumption table, for example, VP7, so as to serve as the 10^{th} power-saving pixel value.

In other words, in Step S340, a color difference operation is performed on the reference pixel value based on the 2^{N*M} reference pixel values, and one reference pixel value is selected from the 2^{N*M} reference pixel values according to the color difference offset range and the color power consumption table to serve as the i^{th} power-saving pixel value. Therefore, in Step S340, as for each reference pixel value, a plurality of reference pixel values having similar color may be obtained, and the reference pixel value that is most power saving is selected from the plurality of reference pixel values having the similar color to serve as the power-saving pixel value corresponding to each reference pixel value.

It should be noted that, considering the color difference operation on two reference pixel values, for example, the reference pixel values VP10 and VP7, in this embodiment, the reference pixel values VP10 and VP7 are respectively converted to a Lab color space, so as to obtain corresponding conversion values (L10, a10, b10) and (L7, a7, b7) respectively. Then, as shown in Formula (I), the color difference formula in the Lab color space is used to calculate a color difference value ΔE10-7 between the reference pixel values VP10 and VP7.

ΔE10-7=\sqrt{(L10−L7)²+(a10−a7)²+(b10−b7)²} Formula (I)

Referring to FIG. 1 again, after the color converting table is created, in Step S140, the color converting table is looked up, so as to convert original pixel values of the plurality of pixels in the target image into a part of the power-saving pixel values. For example, as for the color converting table 400 shown in FIG. 4, if the target image includes 9 pixels, that is, P1-P9, the pixel P1 is first retrieved from the pixels P1-P9 when the color converting table is looked up. Then, a specific index value is searched from the color converting table according to the original pixel value of the pixel P1, for example, if the original pixel value of the pixel P1 is (0, 0, 10), the obtained specific index value is 10. Then, a specific power-saving pixel value (0, 0, 7) corresponding to the specific index value (10) may be retrieved from the 256³ power-saving pixel values according to the specific index value (10). Then, the specific power-saving pixel value (0, 0, 7) is used to replace the original pixel value (0, 0, 10) of the pixel P1. Similarly, after completing the conversion of the original pixel value of the pixel P1, the above steps are repeated until the original pixel values of the pixels P2-P9 are all converted to the corresponding specific power-saving pixel values.

In other words, through the process of looking up the color converting table in Step S140, the original pixel values of all pixels in the target image are replaced by the power-saving pixel values. Then, in Step S150, an output image is generated by using the pixels with the power-saving pixel values, and in Step S160, the output image is displayed through a display panel, in which the display panel is, for example, an OLED display panel. It should be noted that, the output image obtained after performing the conversion through the color converting table has a specific color difference with respect to the original image, and the specific color difference may be adjusted by selecting different color difference offset ranges, which thus cannot be recognized by human eyes. Therefore, the output image can reduce the power consumption of the display panel while satisfying the displaying quality requirement of the electronic device.

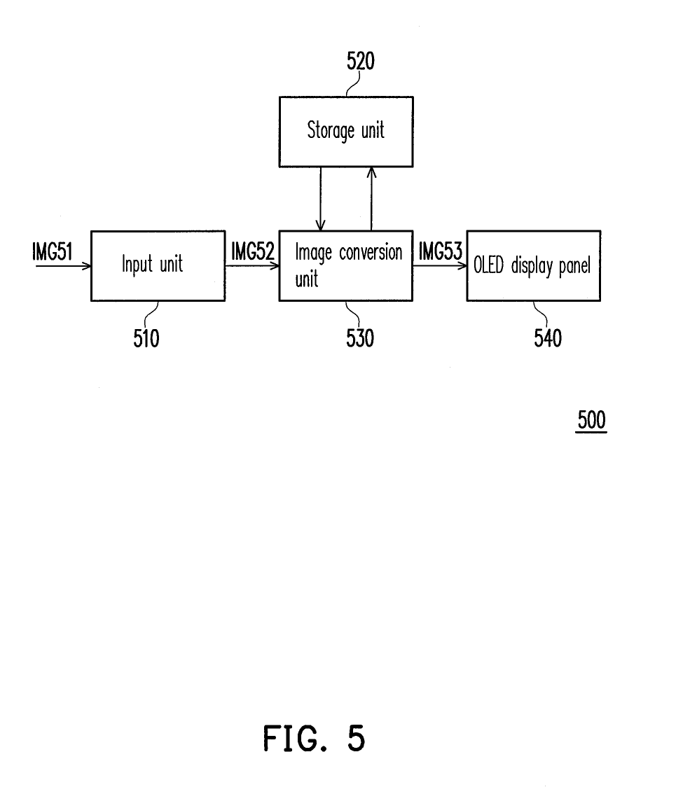

In another aspect, FIG. 5 is a schematic block diagram of a flat panel display according to an embodiment of the present invention. Referring to FIG. 5, a flat panel display 500 includes an input unit 510, a storage unit 520, an image conversion unit 530, and an OLED display panel 540. The input unit 510 is used for receiving an original image IMG51, and converting the original image IMG51 to a specific color space, so as to obtain a target image IMG52 with a resolution of N bits, in which each of a plurality of pixels in the target image IMG52 includes M sub-pixels, and N and M are positive integers.

Furthermore, the storage unit 520 is used for storing a color converting table, and the color converting table is corresponding to a color difference offset range, and records 2^{N*M} power-saving pixel values. Moreover, the image conversion unit 530 converts the original pixel values of the plurality of the pixels in the target image IMG52 into a part of the power-saving pixel values according to the color converting table stored in the storage unit 520. Then, the flat panel display 500 generates an output image IMG53 by using the pixels with the part of the power-saving pixel values, and displays the output image IMG53 through the OLED display panel 540. The detailed operating principles for creating the color converting table and looking up the color converting table by the flat panel display 500 have already been described in the above embodiments, and thus are not repeated here.

In view of the above, the present invention replaces original pixel values of all pixels by power-saving pixel values through looking up the color converting table. Therefore, a specific color difference may exist between the output image and the original image, and the specific color difference can be adjusted by using different color difference offset ranges. Thus, the output image can reduce the power consumption of the display panel while satisfying the displaying quality requirements of the electronic devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image processing method for power saving, comprising:
converting an original image to a specific color space, so as to obtain a target image with a resolution of N bits, wherein each of a plurality of pixels in the target image comprises M sub-pixels, and N and M are positive integers;
creating a color converting table according to a color difference offset range and 2^{N*M} reference pixel values, wherein the color converting table records 2^{N*M} power-saving pixel values;
looking up the color converting table to convert original pixel values of the plurality of pixels in the target image into a part of the power-saving pixel values; and
generating an output image by using the pixels with the part of the power-saving pixel values.

2. The image processing method for power saving according to claim 1, further comprising:
setting a plurality of preset offset ranges; and
selecting one from the preset offset ranges to serve as the color difference offset range.

3. The image processing method for power saving according to claim 1, further comprising:
displaying the output image through a display panel.

4. The image processing method for power saving according to claim 3, wherein the display panel is an organic light emitting diode display panel.

5. The image processing method for power saving according to claim 1, wherein the step of creating the color converting table according to the color difference offset range and the reference pixel values comprises:
setting a power-saving pixel value field in the color converting table, wherein the power-saving pixel value field is used for recording the power-saving pixel values;
generating the reference pixel values;
determining a position for arranging the i^{th} power-saving pixel value according to N sub-pixel values of the i^{th} reference pixel value, such that the power-saving pixel values are sequentially arranged in the power-saving pixel value field according to index values of the color converting table, wherein i is an integer and 0≦i≦(2^{N*M}−1); and
performing a color difference operation on the i^{th} reference pixel value based on the reference pixel values, and selecting one from the reference pixel values according to the color difference offset range and a color power consumption table to serve as the i^{th} power-saving pixel value.

6. The image processing method for power saving according to claim 5, wherein the step of performing the color difference operation on the i^{th} reference pixel value based on the reference pixel values, and selecting one from the reference pixel values according to the color difference offset range and the color power consumption table to serve as the i^{th} power-saving pixel value comprises:
converting the reference pixel values to a Lab color space;
calculating 2^{N*M} color difference values formed between the i^{th} reference pixel value and the reference pixel values by using a color difference formula in the Lab color space;
selecting many color difference values falling in the color difference offset range from the color difference values, and selecting a plurality of specific reference pixel values having similar color with the i^{th} reference pixel value from the reference pixel values; and
selecting a specific reference pixel value having a minimum power consumption from the specific reference pixel values according to the color power consumption table to serve as the i^{th} power-saving pixel value.

7. The image processing method for power saving according to claim 1, wherein the step of looking up the color converting table to convert the original pixel values of the plurality of pixels in the target image into the part of the power-saving pixel values comprises:
retrieving one of the pixels, so as to obtain a specific pixel;
searching a specific index value from the color converting table according to the original pixel value of the specific pixel;
retrieving a specific power-saving pixel value corresponding to the specific index value from the power-saving pixel values;
replacing the original pixel value of the specific pixel by the specific power-saving pixel value; and
re-selecting the specific pixel and repeating the above three steps, until the original pixel value of each of the pixels are replaced by the specific power-saving pixel value one by one.

8. The image processing method for power saving according to claim 1, wherein the specific color space is an RGB color space.

9. A flat panel display, comprising:
an organic light emitting diode display panel;
an input unit, for receiving an original image, and converting the original image to a specific color space, so as to obtain a target image with a resolution of N bits, wherein each of a plurality of pixels in the target image comprises M sub-pixels, and N and M are positive integers;
a storage unit, for storing a color converting table, wherein the color converting table is corresponding to a color difference offset range and records 2^{N*M} power-saving pixel values; and
an image conversion unit, for converting original pixel values of the plurality of pixels in the target image into a part of the power-saving pixel values according to the color converting table, wherein the flat panel display generates an output image by using the pixels with the part of the power-saving pixel values, and displays the output image through the OLED display panel.

10. The flat panel display according to claim 9, wherein the flat panel display further creates the color converting table according to 2^{N*M} reference pixel values and the color difference offset range; the color converting table comprises a power-saving pixel value field for recording the power-saving pixel values; a position for arranging the i^{th} power-saving pixel value is determined according to N sub-pixel values of the i^{th} reference pixel value, such that the power-saving pixel values are sequentially arranged in the power-saving pixel value field according to index values of the color converting table; a color different operation is performed on the i^{th} reference pixel value based on the reference pixel values, and one pixel value is selected from the reference pixel values according to the color difference offset range and a color power consumption table to serve as the i^{th} power-saving pixel value, and i is an integer and 0≦i≦(2^{N*M}−1).

11. The flat panel display according to claim 9, wherein the specific color space is an RGB color space.
